(19) United States
(12) Patent Application Publication
(10) Pub. No.: US 2014/0362927 A1
(43) Pub. Date: Dec. 11, 2014

(54) VIDEO CODEC FLASHING EFFECT REDUCTION

(71) Applicant: Apple Inc., Cupertino, CA (US)

(72) Inventors: Chris Y. Chung, Sunnyvale, CA (US); Douglas Scott Price, San Jose, CA (US); Hsi-Jung Wu, San Jose, CA (US); Xiaosong Zhou, Campbell, CA (US)

(73) Assignee: Apple Inc., Cupertino, CA (US)

(21) Appl. No.: 14/065,981

(22) Filed: Oct. 29, 2013

Related U.S. Application Data
(60) Provisional application No. 61/832,471, filed on Jun. 7, 2013.

(51) Int. Cl. H04N 19/142; H04N 19/119; H04N 19/176

(52) U.S. Cl. CPC H04N 19/00163; H04N 19/00278; H04N 19/00072
USPC 375/240.24

(57) ABSTRACT

A system may include a detector, a controller, and an encoder. The detector may receive data from video input to detect a group of pixels in a video sequence, and may determine whether the group of pixels needs additional bits for encoding. The controller may determine the number of bits for the additional bits and may allocate the additional bits with the number of bits in a data stream. The encoder may by controlled by the controller to encode the group of pixels with the additional bits, and output to the encoded output.

### CROSS-REFERENCE TO RELATED APPLICATIONS

This application claims benefit under 35 U.S.C. §119(e) of U.S. Provisional Application Ser. No. 61/832,471, filed Jun. 7, 2013, which is incorporated herein by reference in its entirety.

### BACKGROUND

Due to data size constraints, video quality must often be compromised in order to meet specific bandwidth limits, both for video capture and for video transmission scenarios. For example, multiple pixels in the video sequence may be determined to have too little changes from frame to frame, and determined that such changes would not be noticeable and thus do not need to be encoded. In such cases, these pixels may be assumed to be the same from one frame to the next frame, the encoded video stream may be encoded to “skip” the non-changing pixels, i.e. the residue image data for these pixels may be “skipped” in the encoding, thus saving data space needed to encode the video stream.

Encoders may use simplistic decision making processes to attempt to encode video-sequences with low cost in computing resources and data bandwidth. However, the resulting video quality for some video sequence may be non-optimal as a result of a lack of processing resources and non-optimal encoding of specific features of the video-sequence.

A “flashing” effect in a video may be seen as a result of a group of pixels or an area that is skipped repeatedly in encoding of a video sequence, which may cause subtle changes in the area to be ignored and accumulated, that when the change in the group of pixels finally gets encoded (for example by an instantaneous decoding refresh (IDR) in the encoded video stream), all the accumulated changes are encoded in a single frame, and a noticeable “flash” effect occurs in the video.

Thus, there may be a need for an improved way of encoding image data to avoid such video anomalies without significantly increasing data size of the video data stream.

### BRIEF DESCRIPTION OF THE DRAWINGS

FIG. 1 illustrates a communication system according to an embodiment of the present disclosure.

FIG. 2 illustrates a video coding system according to an embodiment of the present disclosure.

FIG. 3 illustrates a video decoding system according to an embodiment of the present disclosure.

FIG. 4 illustrates an encoding method according to an embodiment of the present disclosure.

FIG. 5 illustrates an exemplary video image for encoding according to an embodiment of the present disclosure.

### DETAILED DESCRIPTION

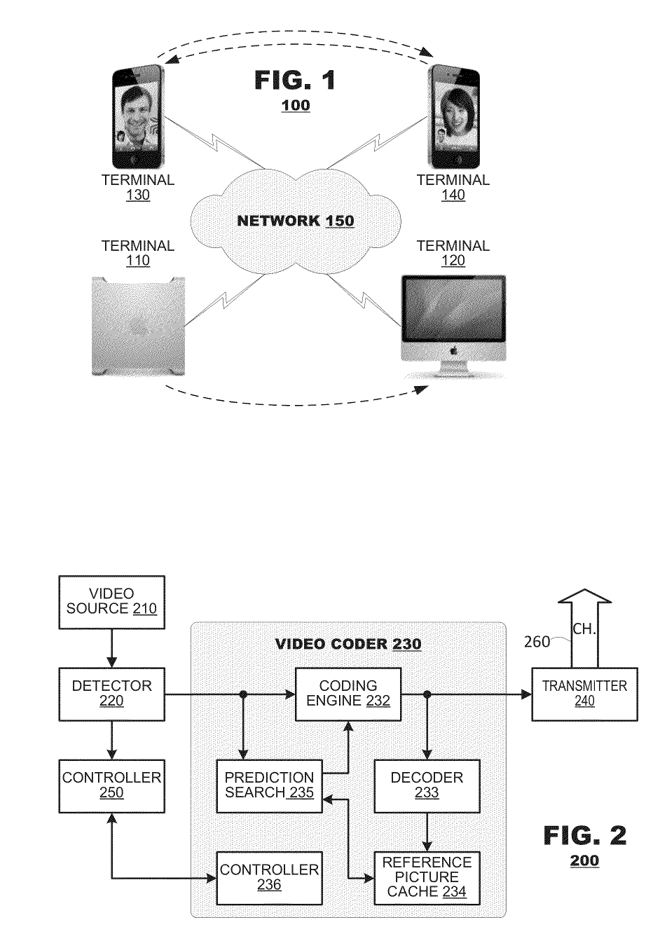

FIG. 1 illustrates a simplified block diagram of a communication system 100 according to an embodiment of the present invention. The system 100 may include at least two terminals 110-120 interconnected via a network 150. For unidirectional transmission of data, a first terminal 110 may code video data at a local location for transmission to the other terminal 120 via the network 150. The second terminal 120 may receive the coded video data of the other terminal from the network 150, decode the coded data and display the recovered video data. Unidirectional data transmission is common in media serving applications and the like.

FIG. 1 illustrates a second pair of terminals 130, 140 provided to support bidirectional transmission of coded video that may occur, for example, during videoconferencing. For bidirectional transmission of data, each terminal 130, 140 may code video data captured at a local location for transmission to the other terminal via the network 150. Each terminal 130, 140 also may receive the coded video data transmitted by the other terminal, may decode the coded data and may display the recovered video data at a local display device.

In FIG. 1, the terminals 110-140 are illustrated as servers, personal computers and smart phones but the principles of the present invention are not so limited. Embodiments of the present invention find application with laptop computers, tablet computers, media players and/or dedicated video conferencing equipment. The network 150 represents any number of networks that convey coded video data among the terminals 110-140, including for example wireline and/or wireless communication networks. The communication network 150 may exchange data in circuit-switched and/or packet-switched channels. Representative networks include telecommunications networks, local area networks, wide area networks and/or the Internet. For the purposes of the present discussion, the architecture and topology of the network 150 is immaterial to the operation of the present invention unless explained herein below.

FIG. 2 is a functional block diagram of a video coding system 200 according to an embodiment of the present invention.

The system 200 may include a video source 210 that provides video data to be coded by the system 200, a detector 220, a video coder 230, a transmitter 240 and a controller 250 to manage operation of the system 200. The detector 220 may receive data from video source 210 to detect a group of pixels in a video sequence, and may determine whether the group of pixels needs additional bits for encoding. The controller 250 may determine the number of bits for the additional bits and may allocate the additional bits with the number of bits in a data stream. The video coder 230 may by controlled by the controller 250 to encode the group of pixels with the additional bits, and output to the transmitter 240.

The video source 210 may provide video to be coded by the system 200. In a media serving system, the video source 210 may be a storage device storing previously prepared video. In a videoconferencing system, the video source 210 may be a camera that captures local image information as a video sequence. Video data typically is provided as a plurality of individual frames that impart motion when viewed in sequence. The frames themselves typically are organized as a spatial array of pixels.

The detector 220 may perform various analytical and signal conditioning operations on video data. The detector 220 may parse input frames into color components (for example, luminance and chrominance components) and also may parse the frames into pixel blocks, spatial arrays of pixel data, which may form the basis of further coding. The detector 220 also may apply various filtering operations to the frame data to improve efficiency of coding operations applied by a video coder 230.

The data from the video source 210 may be raw video data or a previously encoded video stream. The system 200 may perform the encoding in real-time, in post-capture processing, or in batch mode, etc.

The detector 220 may detect the group of pixels with corresponding frame-to-frame residue data of a size less than a predetermined threshold, and the detector 220 may determine that the group of pixels needs the additional bits for the corresponding frame-to-frame residue data.

The group of pixels may include a macroblock (MB) in a frame of the video sequence.

Several techniques may be used, for example in real-time embedded applications, to significantly improve the perceived quality of video by quickly determining the type of sequence being encoded and adapting the pre-processing, QP-modulation, mode-decision, and rate-control decisions to achieve a more optimal encoding given the particular type of scene and characteristics of the video.

Many QP-modulation schemes may use spatial complexity measurements to assist in modulation decisions, and these values may be re-used without adding further spatial complexity to help determine the non-moving (non-changing) visually salient pixel areas of the scene. For example, using a patch-based spatial complexity measurement that may be not affected by noise-levels, as well as mean values, neighboring patch values, and other statistics, the system 200 may quickly determine both the saliency of the area (whether or not a viewer of the scene may be likely to notice the area) as well as whether or not that the area changes significantly over a period of time or a number of frames. The specific pixel areas may be given more bits in specific frames in the bandwidth for encoding, due to the saliency of the area as well as the fact that these areas may be more likely to propagate into future frames as they may be not moving.

Analysis of the video may be done with a group of frames to determine which pixel areas need additional bits for the specific frames. Pixel areas may change status in different segments of the video sequence, for example, a specific pixel area may be visually salient and need additional bits in one segment of video sequence, and may become non-salient in the next segment. The detector 220 may continuously detect pixel areas and determine whether each specific pixel area needs additional bits for encoding.

When encoding at lower-bitrates, it may become very expensive to prevent MB's from being skipped as the QP would have to be lowered significantly in order to allow the residuals to be large enough. Certain considerations may be made to determine when and where (which temporal spatial pixel in the output data stream) extra bits should be allocated, for example to reduce the flashing effect.

The detector 220 may determine the visually-salient non-moving (non-changing) parts of the scene. Moving (changing) parts of the scene may not have any subtle built up changes, and non-visually salient areas won't be as easily noticed. Therefore it may be prudent to only attempt to reduce skipping and allocate more bits to salient non-moving areas, to improve visual quality without significantly increasing the size of the encoded video.

The detector 220 may be implemented to quickly and effectively determine the areas of the scene which may be both non-moving and visually salient, independent of noise levels.

Low spatial complexity regions, for example, an area of uniform color, may easily result in skipped MB's due to the small residual values that may occur after prediction, however skipping in these regions may often result in a noticeably blocky or banded area. Detecting these regions, particularly when then may be not moving, and allocating enough bits to prevent too-frequent skipped-MB's without unnecessarily encoding too much noise may result in a significantly improved video quality.

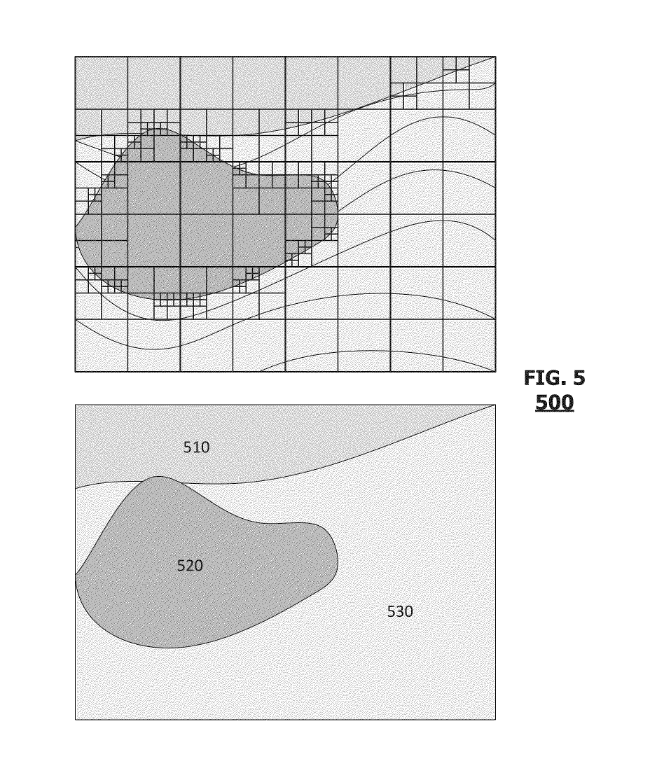

For example, as illustrated in FIG. 5, a video image 500 for encoding may be divided into plurality of groups of pixels, or pixel regions, which are illustrated here as grids of squares dividing the image 500. The image 500 may contain multiple image regions 510, 520, and 530, which may represent different objects or backgrounds in the image 500.

The division of pixel regions may be done to maximize coding and compression efficiencies or image quality, for example, boundary regions between image regions 510, 520, and 530 may be divided into additional pixels regions (more smaller squares) for additional coding and better image quality, while non-boundary regions may be compressed more heavily. The individual pixel regions may be considered as coding units (CU) within a coding tree unit (CTU) for the encoding of the video image 500.

Here, image region 520 may represent a rock, image region 530 may represent water in a river, and image region 510 may represent a shoreline. The pixels regions containing image region 520 for example, may be detected by detector 220 as visually salient (and non-moving), and thus need additional bits for encoding. At the same time, pixel regions containing image region 530 may be detected as visually non-salient, as the pixels for the river water may be changing too rapidly to be efficiently coded (and would not be noticeable if the non-salient pixel regions of image region 530 are degraded slightly in quality).

The system 200 may be implemented to detect low-spatial complexity regions independent of noise-levels, particularly those that may be not moving, and allocate a number of bits as estimated as needed, in order to prevent poorly encoding areas which may be inexpensive to encode and may often be very noticeable.

The controller 250 may determine how and/or when in the data stream to allocate the additional bits. An intermittent or pulsed allocation may be used, for example, allocate the additional bits for the visually-salient non-moving pixel areas once every 3 frames, in order to only encode the additional information every so often. This keeps the cost of encoding the regions as non-skipped at a minimum while progressively encoding small changes so that there may be no large accumulation of changes that may result in a “flash”.

Alternative to intermittent/pulsed allocation, the amount of accumulated change in a non-moving area may be stored and measured to compare to a predetermined threshold of change, and when there has been a significant enough change (greater than the threshold), extra bits may be allocated to allow the relevant pixel areas to be encoded, i.e. not “skipped.” Otherwise, if the changes are not significant (less than the threshold), then the relevant pixel areas may remain “skipped” in the encoding.

A combination or variation of above allocations may be done by the controller 250 based upon different parameters, such as output device display size, display resolution, viewing distance, ambient light, brightness, etc. For example, larger display size and display resolution may require higher image quality, and salient non-moving pixel areas may need to be encoded with extra bits more often. Smaller viewing distance and greater ambient light may also require higher image quality. Such parameters may be received by the system 200 from an user device (not shown, for example, mobile phone, TV, computer), and the system 200 may use such parameters to adjust controls in the controller 250 to alter the encoding accordingly.

The controller 250 may allocate the additional bits by reducing bits for other portions of the video stream.

The controller 250 may allocate the additional bits by reducing bits for frames adjacent to a current frame of the video stream. Or the additional bits may be allocated from across multiple frames or groups of frames in the video stream.

The controller 250 may allocate the additional bits by reducing bits for other pixels outside of the group of pixels.

The controller 250 may allocate the additional bits by at least one of reducing Quality Parameter (QP) value of the group of pixels and increasing QP value of other pixels outside of the group of pixels.

The video coder 230 may perform coding operations on the video sequence to reduce the video sequence's bit rate. The video coder 230 may include a coding engine 232, a local decoder 233, a reference picture cache 234, a predictor 235 and a controller 236. The coding engine 232 may code the input video data by exploiting temporal and spatial redundancies in the video data and may generate a datastream of coded video data, which typically has a reduced bit rate as compared to the datastream of source video data. As part of its operation, the video coder 230 may perform motion compensated predictive coding, which codes an input frame predictively with reference to one or more previously-coded frames from the video sequence that were designated as “reference frames.” In this manner, the coding engine 232 codes differences between pixel blocks of an input frame and pixel blocks of reference frame(s) that are selected as prediction reference(s) to the input frame.

The local decoder 233 may decode coded video data of frames that are designated as reference frames. Operations of the coding engine 232 typically are lossy processes. When the coded video data is decoded at a video decoder (not shown in FIG. 2), the recovered video sequence typically is a replica of the source video sequence with some errors. The local decoder 233 replicates decoding processes that will be performed by the video decoder on reference frames and may cause reconstructed reference frames to be stored in the reference picture cache 234. In this manner, the system 200 may store copies of reconstructed reference frames locally that have common content as the reconstructed reference frames that will be obtained by a far-end video decoder (absent transmission errors).

The predictor 235 may perform prediction searches for the coding engine 232. That is, for a new frame to be coded, the predictor 235 may search the reference picture cache 234 for image data that may serve as an appropriate prediction reference for the new frames. The predictor 235 may operate on a pixel block-by-pixel block basis to find appropriate prediction references. In some cases, as determined by search results obtained by the predictor 235, an input frame may have prediction references drawn from multiple frames stored in the reference picture cache 234.

The controller 236 may manage coding operations of the video coder 230, including, for example, selection of coding parameters to meet a target bit rate of coded video. Typically, video coders operate according to constraints imposed by bit rate requirements, quality requirements and/or error resiliency policies. The controller 236 may select coding parameters for frames of the video sequence in order to meet these constraints. For example, the controller 236 may assign coding modes and/or quantization parameters to frames and/or pixel blocks within frames.

The transmitter 240 may buffer coded video data to prepare it for transmission to the far-end terminal (not shown) via a communication channel 260. The transmitter 240 may merge coded video data from the video coder 230 with other data to be transmitted to the terminal, for example, coded audio data and/or ancillary data streams (sources not shown).

The controller 250 may manage operation of the system 200. During coding, the controller 250 may assign to each frame a certain frame type (either of its own accord or in cooperation with the controller 236), which can affect the coding techniques that are applied to the respective frame. For example, frames often are assigned as one of the following frame types:

An Intra Frame (I frame) is one that is coded and decoded without using any other frame in the sequence as a source of prediction.

A Predictive Frame (P frame) is one that is coded and decoded using earlier frames in the sequence as a source of prediction.

A Bidirectionally Predictive Frame (B frame) is one that is coded and decoded using both earlier and future frames in the sequence as sources of prediction.

Frames commonly are parsed spatially into a plurality of pixel blocks (for example, blocks of 4×4, 8×8 or 16×16 pixels each) and coded on a pixel block-by-pixel block basis. Pixel blocks may be coded predictively with reference to other coded pixel blocks as determined by the coding assignment applied to the pixel blocks' respective frames. For example, pixel blocks of I frames can be coded non-predictively or they may be coded predictively with reference to pixel blocks of the same frame (spatial prediction). Pixel blocks of P frames may be coded non-predictively, via spatial prediction or via temporal prediction with reference to one previously coded reference frame. Pixel blocks of B frames may be coded non-predictively, via spatial prediction or via temporal prediction with reference to one or two previously coded reference frames.

The video coder 230 may perform coding operations according to a predetermined protocol, such as H.263, H.264, MPEG-2, HEVC. In its operation, the video coder 230 may perform various compression operations, including predictive coding operations that exploit temporal and spatial redundancies in the input video sequence. The coded video data, therefore, may conform to a syntax specified by the protocol being used.

In an embodiment, the transmitter 240 may transmit additional data with the encoded video. The additional data may include collected statistics on the video frames or details on operations performed by the detector 220. The additional data may be transmitted in a channel established by the governing protocol for out-of-band data. For example, the transmitter 240 may transmit the additional data in a supplemental enhancement information (SEI) channel and/or a video usability information (VUI) channel. Alternatively, the video coder 230 may include such data as part of the encoded video frames.

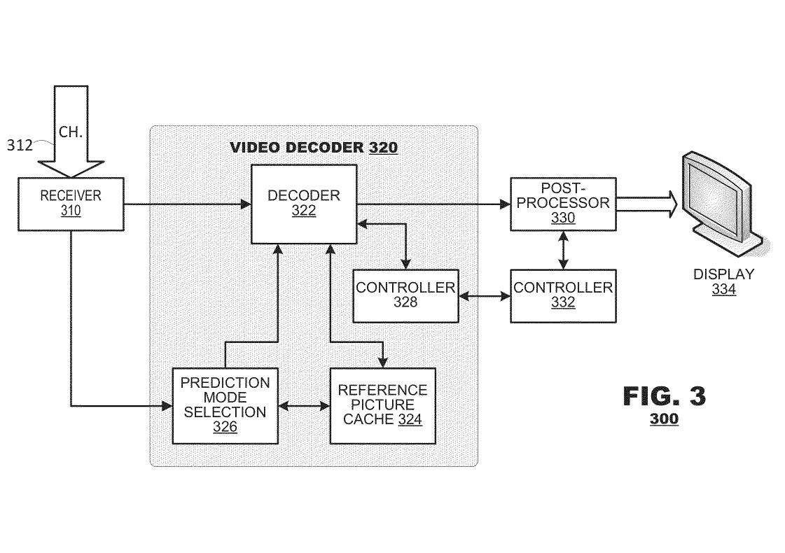

FIG. 3 is a functional block diagram of a video decoding system 300 according to an embodiment of the present invention.

The video decoding system 300 may include a receiver 310 that receives encoded video data, a video decoder 320, a post-processor 330, a controller 332 to manage operation of the system 300 and a display 334 to display the decoded video data.

The receiver 310 may receive video to be decoded by the system 300. The encoded video data may be received from a channel 312. The receiver 310 may receive the encoded video data with other data, for example, coded audio data and/or ancillary data streams. The receiver 310 may separate the encoded video data from the other data.

The video decoder 320 may perform decoding operation on the video sequence received from the receiver 310. The video decoder 320 may include a decoder 322, a reference picture cache 324, and a prediction mode selection 326 operating under control of controller 328. The decoder 322 may reconstruct coded video data received from the receiver 310 with reference to reference pictures stored in the reference picture cache 324. The decoder 322 may output reconstructed video data to the post-processor 330, which may perform additional operations on the reconstructed video data to condition it for display. Reconstructed video data of reference frames also may be stored to the reference picture cache 324 for use during decoding of subsequently received coded video data.

The decoder 322 may perform decoding operations that invert coding operations performed by the video coder 230 (shown in FIG. 2). The decoder 322 may perform entropy decoding, dequantization and transform decoding to generate recovered pixel block data. Quantization/dequantization operations are lossy processes and, therefore, the recovered pixel block data likely will be a replica of the source pixel blocks that were coded by the video coder 230 (shown in FIG. 2) but may include some error. For pixel blocks coded predictively, the transform decoding may generate residual data; the decoder 322 may use motion vectors associated with the pixel blocks to retrieve predicted pixel blocks from the reference picture cache 324 to be combined with the prediction residuals. The prediction mode selector 326 may identify a temporal prediction mode being used for each pixelblock of an encoded frame being decoded and request the needed data for the decoding to be read from the reference picture cache 324. Reconstructed pixel blocks may be reassembled into frames and output to the post-processor 330.

The post-processor 330 may perform video processing to condition the recovered video data for rendering, commonly at a display 334. Typical post-processing operations may include applying deblocking filters, edge detection filters, ringing filters and the like. The post-processor 330 may output recovered video sequence for rendering on the display 334 or, optionally, stored to memory (not shown) for later retrieval and display. The controller 332 may manage operation of the system 200.

The video decoder 320 may perform decoding operations according to a predetermined protocol, such as H.263, H.264, MPEG-2, HEVC. In its operation, the video decoder 320 may perform various decoding operations, including predictive decoding operations that exploit temporal and spatial redundancies in the encoded video sequence. The coded video data, therefore, may conform to a syntax specified by the protocol being used.

In an embodiment, the receiver 310 may receive additional data with the encoded video. The additional data may include collected statistics on the video frames or details on operations performed by the detector 220 (shown in FIG. 2). The additional data may be received via a channel established by the governing protocol for out-of-band data. For example, the receiver 310 may receive the additional data via supplemental enhancement information (SEI) channel and/or video usability information (VUI) channel. Alternatively, the additional data may be included as part of the encoded video frames. The additional data may be used by the video decoder 320 and/or the post-processor 330 to properly decode the data and/or to more accurately reconstruct the original video data.

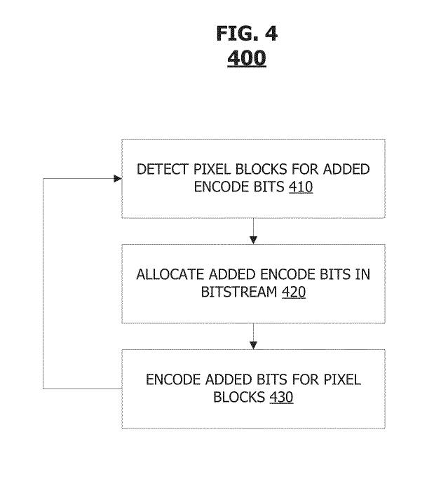

FIG. 4 illustrates an exemplary method 400 for encoding video.

The method 400 may include block 410, detecting, by a detector, a group of pixels in a video sequence and determining whether the group of pixels need additional bits for encoding.

At block 420, determining, by a controller, number of bits for the additional bits and allocating the additional bits with the number of bits in a data stream.

At block 430, encoding, by an encoder, the group of pixels with the additional bits.

The method 400 may continuously cycle through for all the groups of pixels in the video sequence as needed.

In an embodiment, the method 400 may detect areas of video that depict human skin, which may be visually salient as small changes may be very noticeable, and perform the encoding to prevent skipping and the flashing effect in the relevant areas.

A very fast real-time skin-biasing technique may distinguish skin from non-skin areas with good probability. This may be combined with real-time face detection system or algorithms to first detect scenes/segments/frames containing images of human subjects, and then to bias (adjust) the areas with skin to improve quality in those areas.

For example, once a face area may be determined in a frame, pixel statistics of the face area may be used to determine the general skin color for the person and the QP of surrounding areas may be reduced to improve image quality based on probability metrics on whether or not the area may be skin. This may be done either in an HSV color-space, giving special consideration to hue values or an approximation of HSV using Y-Cb-Cr in order to save processing time.

The color-space of the image may be adjusted to shift the skin color tone of pixels depicting skin toward some ideal color range. Or the white balance of the image may be adjusted to shift the skin color tone of pixels depicting skin toward some ideal color range.

The overall luminance of the scene may be used to adjust the acceptable range of skin-tone values. A first-order classification may be done to distinguish whether the hue falls into the range of general skin-color and a second-order classification may be used on H, S, and V values once a sample area has been determined using face-detection values. Values that may be on the border of the probability threshold may be given a lower bias. Multiple thresholds may be used to classify each area into discrete probabilities of being skin and neighboring patch information may be used to modulate the probability of the current patch.

In an embodiment, a QP-modulation technique may be used to utilize a global-motion vector and device accelerometer and gyroscope information to modulate QP values when an image capture device (for example a camera or a camcorder) may be shaking or moving. In doing so, non-salient pixel areas may be detected, and the encoder may reduce or avoid excessive encoding bits for these areas to reduce data size or to shift bits to more salient pixel areas.

When a scene may be relatively still but shaking due to the image capture device being held in the hand, the small regions on the border of the scene may go in and out, causing a significant cost in bits due to the corresponding MB's being intra-coded. These areas may be considered transient or visually unstable due to the shaking of the camera, and therefore the encoded quality of the MB's may not need to be propagated or carried into future frames, because such high quality of pixel may not be visually noticeably in the motion blur of the video. It may be therefore generally not worthwhile to encode these transient areas well and raising the QP values on these areas may significantly reduce the bit-rate or increase the quality of other more stable or salient areas of the scene.

When the camera may be moving, the global motion vector may be used to determine the direction and velocity of motion. Using an assumption of constant velocity, the trailing MB's (macro-blocks which are predicted as soon no longer be in the scene) may then have their QP raised and the extra bits allocated to other areas or more stable or more salient areas of the scene. This may increase actual image quality since the trailing MB's do not propagate into future frames, as well as perceptual image quality based on the fact that the eyes tend to focus on the new elements of the scene when there may be motion in the scene. The camera's global motion-vector may be determined in real-time using the device's gyroscope and accelerometer.

In an embodiment, the method 400 may determine the in-focus region of the captured scene as determined by metrics obtained from the camera image signal processing (ISP) or through video-processing.

Camera ISP's for cameras with moveable lenses frequently use a focus-sweep process in which sharpness scores for the image may be calculated to determine an optimal lens position. Once the optimal lens position may be determined, the sharpness scores for that position may be used in addition to blur-detection video-processing techniques to determine which areas may be in focus for a particular scene. The in-focus areas, as salient areas of interest, may be given a lower QP to increase image quality.

In an embodiment, the method 400 may determine when transient objects move in and out of the scene and prevent auto-exposure adjustments due to these transient objects.

When transient objects have significantly different luminance than the overall scene luminance, an auto-exposure flash may occur which may reduce visual quality of the image and may significantly increase the bit-rate of the scene. In order to reduce this effect, transient objects may be detected and the auto-exposure may be locked during scenes in which these transient objects may be present in order to reduce or eliminate auto-exposure flashes.

It is appreciated that the disclosure is not limited to the described embodiments, and that any number of scenarios and embodiments in which conflicting appointments exist may be resolved.

Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof.

The present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1. A system comprising:
a detector detecting a group of pixels in a video sequence and determining whether the group of pixels need additional bits for encoding;
a controller determining number of bits for the additional bits and allocating the additional bits with the number of bits in a data stream; and
an encoder encoding the group of pixels with the additional bits.

2. The system of claim 1, wherein the detector detects the group of pixels with corresponding frame-to-frame residue data of a size less than a predetermined threshold, and the detector determines that the group of pixels needs the additional bits for the corresponding frame-to-frame residue data.

3. The system of claim 1, wherein the group of pixels comprise a macroblock in a frame of the video sequence.

4. The system of claim 1, wherein the controller allocates the additional bits by reducing bits for other portions of the video stream.

5. The system of claim 1, wherein the controller allocates the additional bits by reducing bits for frames adjacent to a current frame of the video stream.

6. The system of claim 1, wherein the controller allocates the additional bits by reducing bits for other pixels outside of the group of pixels.

7. The system of claim 1, wherein the controller allocates the additional bits by at least one of reducing QP value of the group of pixels and increasing QP value of other pixels outside of the group of pixels.

8. A method comprising:
detecting, by a detector, a group of pixels in a video sequence and determining whether the group of pixels need additional bits for encoding;
determining, by a controller, number of bits for the additional bits and allocating the additional bits with the number of bits in a data stream; and
encoding, by an encoder, the group of pixels with the additional bits.

9. The method of claim 8, wherein the detector detects the group of pixels with corresponding frame-to-frame residue data of a size less than a predetermined threshold, and the detector determines that the group of pixels needs the additional bits for the corresponding frame-to-frame residue data.

10. The method of claim 8, wherein the group of pixels comprise a macroblock in a frame of the video sequence.

11. The method of claim 8, wherein the controller allocates the additional bits by reducing bits for other portions of the video stream.

12. The method of claim 8, wherein the controller allocates the additional bits by reducing bits for frames adjacent to a current frame of the video stream.

13. The method of claim 8, wherein the controller allocates the additional bits by reducing bits for other pixels outside of the group of pixels.

14. The method of claim 8, wherein the controller allocates the additional bits by at least one of reducing QP value of the group of pixels and increasing QP value of other pixels outside of the group of pixels.

15. A non-transitory computer readable medium, storing instruction codes, executable by a processor to perform:
detecting, by a detector, a group of pixels in a video sequence and determining whether the group of pixels need additional bits for encoding;
determining, by a controller, number of bits for the additional bits and allocating the additional bits with the number of bits in a data stream; and
encoding, by an encoder, the group of pixels with the additional bits.

16. The non-transitory computer readable medium of claim 15, wherein the detector detects the group of pixels with corresponding frame-to-frame residue data of a size less than a predetermined threshold, and the detector determines that the group of pixels needs the additional bits for the corresponding frame-to-frame residue data.

17. The non-transitory computer readable medium of claim 15, wherein the group of pixels comprise a macroblock in a frame of the video sequence.

18. The non-transitory computer readable medium of claim 15, wherein the controller allocates the additional bits by reducing bits for other portions of the video stream.

19. The non-transitory computer readable medium of claim 15, wherein the controller allocates the additional bits by reducing bits for frames adjacent to a current frame of the video stream.

20. The non-transitory computer readable medium of claim 15, wherein the controller allocates the additional bits by reducing bits for other pixels outside of the group of pixels.
